(19) United States
(12) Patent Application Publication
(10) Pub. No.: US 2013/0280015 A1
(43) Pub. Date: Oct. 24, 2013

(54) DATA EDITING APPARATUS AND PROGRAM

(71) Applicant: RISO KAGAKU CORPORATION, Tokyo (JP)

(72) Inventor: Yuuko ENOMOTO, Ibaraki-ken (JP)

(73) Assignee: RISO KAGAKU CORPORATION, Tokyo (JP)

(21) Appl. No.: 13/867,639

(22) Filed: Apr. 22, 2013

(30) Foreign Application Priority Data
Apr. 23, 2012 (JP) 2012-097354

(51) Int. Cl. B42C 99/00

(52) U.S. Cl. CPC B42C 99/00
USPC 412/11

(57) ABSTRACT

In casing-in bookbinding, in which a book sheet block of book sheets is wrapped with a cover, an input of pieces of information about the length of a short side of the book sheets, the length of a long side of the cover, and the thickness of a spine cover of the cover is received. Judgment is made, based on the received information, whether the length of the long side of the cover is less than a value obtained by adding the thickness of the spine cover to twice the length of the short side of the book sheets. If the length of the long side of the cover is less than the obtained value, an alert is issued to urge the user to change at least one of the pieces of information.

### BACKGROUND OF THE INVENTION

1. Field of the Invention

The present invention relates to a data editing apparatus and program for casing-in bookbinding. Specifically, the present invention relates to a data editing apparatus and program for performing a casing-in bookbinding operation, in which book sheets and a cover are printed based on image data, and the book sheets are wrapped with the cover (the term “wrapped” means attaching a cover to book sheets in bookbinding).

2. Description of the Related Art

Conventionally, casing-in bookbinding is known. In casing-in bookbinding, a book is produced by wrapping, with a cover, a book sheet block (a text block, or the like) composed of plural sheets of book paper that are bound together (hereinafter, “book paper” will also be referred to as book sheet). Further, a data editing apparatus and program for editing image data about the cover and the book sheets is also known. In the casing-in bookbinding, the book sheet block is wrapped with the cover to produce the book, as described above. Therefore, the size of the cover should be larger than the size of the book sheets. Hence, it is necessary that the edit area of image data about the cover is larger than the edit area of image data about the book sheets when the image data are edited. Japanese Patent No. 4677342 (Patent Document 1) proposes a technique for preventing erroneous selection of paper for book sheets the size of which is larger than the size of paper for a cover when a print condition of the book sheets is set.

However, even if the paper for the cover is larger than the paper for the book sheets, the size of the cover is not always appropriate to constitute the book, booklet, brochure or the like. Therefore, a user, himself or herself, needs to set the size of an edit area in which image data about the cover are represented when the image data about the cover are edited.

### SUMMARY OF THE INVENTION

However, the edit area of the image data about the cover that has been set by the user is still not always appropriate to constitute the book or the like. If a bookbinding operation is performed directly based on the image data, there is a risk of defective bookbinding due to a mismatch between the size of the cover and the size of the book sheets. For example, the cover may be too small to wrap the book sheet block, which is composed of the book sheets that have been bound together. Therefore, it is necessary to check whether information about the size of the edit area of the cover that has been input by the user is appropriate to constitute the book or the like. However, Patent Document 1 is silent about checking the size of the edit area that is set by the user, and in which the image data about the cover are represented.

In view of the foregoing circumstances, it is an object of the present invention to provide a data editing apparatus and program that can prevent defective bookbinding in which a cover is too small to wrap a book sheet block composed of book sheets that are bound together.

To solve the aforementioned problems, a data editing apparatus of the present invention is a data editing apparatus for performing a bookbinding operation, in which book sheets and a cover are printed based on image data, and the book sheets are wrapped with the cover, the apparatus comprising:

an input receiving unit that receives, from a user, an input of pieces of information about the length of the top or bottom side of the book sheets, the length of the top or bottom side of the cover, and the thickness of a spine cover of the cover to set an edit area of the cover represented by the image data; and

an alert unit that judges, based on the received pieces of information, whether the length of the top or bottom side of the cover is less than a value obtained by adding the thickness of the spine cover to twice the length of the top or bottom side of the book sheets, and that issues an alert for urging the user to change at least one of the pieces of information when the length of the top or bottom side of the cover is less than the value obtained by adding the thickness of the spine cover to twice the length of the top or bottom side of the book sheets.

A data editing program of the present invention causes a computer to function as a data editing apparatus by making the input receiving unit function as an input receiving means, and by making the alert unit function as an alert means.

Here, in the data editing apparatus and program of the present invention, the term “image data” means data about images representing a cover and book sheets. The phrase “edit area of the cover” means an area for editing the image representing the cover. Further, the expression “set an edit area of the cover” means setting each of the length of the top or bottom side of the “edit area of the cover” and the length of the spine or edge (fore edge) side of the “edit area of the cover”. Further, the phrase “the top or bottom side” is a side on the top or bottom side of a book or the like when the book or the like is produced by a bookbinding operation based on the image data. Further, the expression “pieces of information about the length of the top or bottom side of the book sheets, the length of the top or bottom side of the cover, and the thickness of a spine cover of the cover” means pieces of information based on which the length of the top or bottom side of the book sheets, the length of the top or bottom side of the cover, and the thickness of the spine cover of the cover are recognizable. The pieces of information are not limited to the values, themselves, of the length of the top or bottom side of the book sheets, the length of the top or bottom side of the cover, and the thickness of the spine cover of the cover.

In the data editing apparatus of the present invention, the alert unit may issue the alert when a value obtained by subtracting twice the length of the top or bottom side of the book sheets and the thickness of the spine cover from the length of the top or bottom side of the cover is greater than or equal to a threshold. Further, the alert unit may issue an alert to urge the user to change the piece of information about the length of the top or bottom side of the cover when the length of the top or bottom side of the cover is greater than or equal to a second threshold.

According to the data editing apparatus and program of the present invention, when an input of pieces of information about the length of the top or bottom side of the book sheets, the length of the top or bottom side of the cover, and the thickness of a spine cover of the cover is received from a user to set an edit area of the cover represented by the image data, judgment is made, based on the received pieces of information, whether the length of the top or bottom side of the cover is less than a value obtained by adding the thickness of the spine cover to twice the length of the top or bottom side of the book sheets, and an alert for urging the user to change at least one of the pieces of information is issued when the length of the top or bottom side of the cover is less than the value obtained by adding the thickness of the spine cover to twice the length of the top or bottom side of the book sheets. Therefore, it is possible to secure the edit area of the cover the length of which is sufficient to constitute the book. Specifically, it is possible to secure the edit area of the cover the length of the top or bottom side of which is greater than or equal to the value obtained by adding the thickness of the spine cover to twice the length of the top or bottom side of the book sheets. Hence, it is possible to prevent defective bookbinding in which the cover is too small to wrap the book sheet block.

Further, according to the data editing apparatus of the present invention, an alert may be issued also when a value obtained by subtracting twice the length of the top or bottom side of the book sheets and the thickness of the spine cover from the length of the top or bottom side of the cover is greater than or equal to a threshold. In such a case, it is possible to prevent defective bookbinding in which an excessive part of the cover, which wraps the book sheet block, sticks out from the book sheet block even if an edge portion of the cover is cut in bookbinding.

Further, according to the data editing apparatus of the present invention, the alert unit may issue an alert to urge the user to change the piece of information about the length of the top or bottom side of the cover when the length of the top or bottom side of the cover is greater than or equal to a second threshold. In such a case, it is possible to prevent defective bookbinding caused by the size of the cover that is too large to be received by the bookbinding apparatus.

Note that the program of the present invention may be provided being recorded on a computer readable medium. Those who are skilled in the art would know that computer readable media are not limited to any specific type of device, and include, but are not limited to: floppy disks, CD's RAM'S, ROM's, hard disks, magnetic tapes, and internet downloads, in which computer instructions can be stored and/or transmitted. Transmission of the computer instructions through a network or through wireless transmission means is also within the scope of this invention. Additionally, computer instructions include, but are not limited to: source, object and executable code, and can be in any language including higher level languages, assembly language, and machine language.

### BRIEF DESCRIPTION OF THE DRAWINGS

FIG. 1 is a schematic diagram illustrating the configuration of a casing-in bookbinding system;

FIG. 2 is a block diagram of a data edit unit;

FIG. 3A is a diagram illustrating a screen for editing cover print image (No. 1);

FIG. 3B is a diagram illustrating a screen for editing cover print image (No. 2);

FIG. 4 is a diagram illustrating a screen for editing book sheet print image;

FIG. 5 is a diagram illustrating a screen for setting;

FIG. 6A is a schematic diagram illustrating a book sheet edit area;

FIG. 6B is a schematic diagram illustrating a cover edit area;

FIG. 7 is a diagram illustrating an alert screen; and

FIG. 8 is a flowchart showing processing for setting cover image data.

### DESCRIPTION OF THE PREFERRED EMBODIMENTS

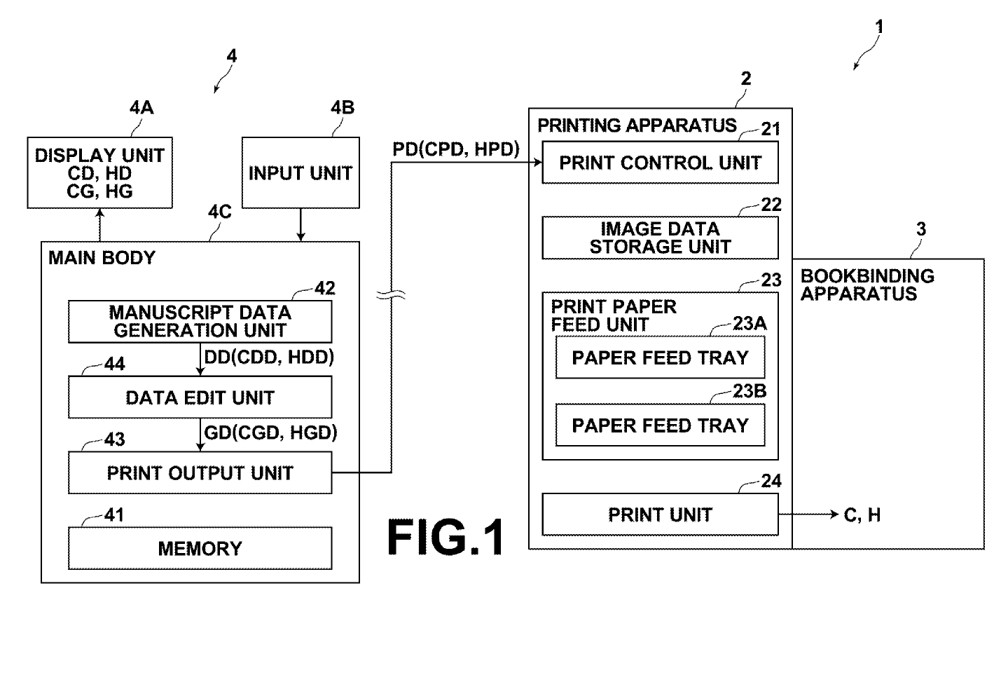

Hereinafter, embodiments of the present invention will be described with reference to drawings. FIG. 1 is a schematic diagram illustrating the configuration of a casing-in bookbinding system 1 including a data edit unit 44 according to an embodiment of the present invention. As illustrated in FIG. 1, the casing-in bookbinding system 1 includes a printing apparatus 2, a bookbinding apparatus 3 next to the printing apparatus 2, and a computer 4 connected to the printing apparatus 2 through a network.

In the casing-in bookbinding system 1, the computer 4 generates manuscript data DD, and generates image data GD based on the manuscript data DD, and generates print data PD based on the image data GD. Further, the printing apparatus 2 prints out cover C and plural book sheets H based on the print data PD. Further, the bookbinding apparatus 3 produces a book, a booklet, a brochure or the like by binding the plural book sheets H together, and by wrapping the plural book sheets H with the cover C.

Manuscript D includes cover manuscript CD, which is composed of cover C, and book sheet manuscript HD, which is composed of plural book sheets H. A book or the like is produced based on the manuscript D by bookbinding, in which the plural book sheets H are wrapped with the cover C. The manuscript data DD include cover manuscript data CDD, which represent the cover manuscript CD, and book sheet manuscript data HDD, which represent the book sheet manuscript HD.

The image data GD include cover image data CGD, which represent a print image of the cover C (hereinafter, referred to as cover image CG), and plural sets of book sheet image data HGD, which represent print images of the plural book sheets H (hereinafter, referred to as book sheet images HG). The print data PD include cover print data CPD, which are print job data of the cover C, and book sheet print data HPD, which are print job data of the book sheets H. The print data PD are composed of PDL (Page Description Language) data or raster data.

First, the printing apparatus 2 will be described. The printing apparatus 2 receives print data PD from the computer 4 through a network, and prints out cover C on paper for the cover based on cover print data CPD and plural book sheets H on paper for the book sheets based on book sheet print data HPD. The printing apparatus 2 includes a print control unit 21, an image data storage unit 22, a print paper feed unit 23, and a print unit 24.

The print control unit 21 controls the whole printing apparatus 2 by controlling each unit of the printing apparatus 2. The print control unit 21 receives print data PD from the computer 4, and loads image data GD based on the print data PD. The print control unit 21 loads cover image data CGD based on cover print data CPD, and loads plural sets of book sheet image data HGD based on book sheet print data HPD.

The image data storage unit 22 stores the cover image data CGD and the plural sets of book sheet image data HGD until printing is performed. The print paper feed unit 23 feeds paper for a cover or paper for book sheets to the print unit 24. The print paper feed unit 23 stores paper for a cover in a paper feed tray 23A, and paper for book sheets in a paper feed tray 23B. The print paper feed unit 23 stores information, such as the sizes, the thicknesses, and the formats of the stored paper for a cover and the stored paper for book sheets.

The print unit 24 prints cover C and/or plural book sheets H based on image data GD. The print unit 24 prints cover C on paper for a cover based on cover image data CGD. The print unit 24 prints plural book sheets H on paper for book sheets based on book sheet image data HGD. As the print unit 24, a stencil print printer, an inkjet printer, a laser printer, and the like may be used. The book sheet print data HPD also include number-of-pages information and print condition information as to whether printing is one side printing or both sides printing. The print control unit 21 makes the print unit 24 print a cover on paper for the cover based on these kinds of information.

Next, the bookbinding apparatus 3 will be described. The bookbinding apparatus 3 is a casing-in bookbinding apparatus. The bookbinding apparatus 3 receives cover C and plural book sheets H from the printing apparatus 2. In the embodiments of the present invention, it is assumed that the bookbinding apparatus 3 produces a book the size of the top or bottom side of which is less than the size of the spine or edge side of the book, and the spread size of which is greater than the size of the spine or edge side of the book. Therefore, in the embodiments of the present invention, the top or bottom side of book sheets recited in the claims of the present application is regarded as the short side of the book sheets, and the top or bottom side of a cover recited in the claims of the present application is regarded as the long side of the cover. Hence, when the bookbinding apparatus 3 produces a book the size of the top or bottom side of which is greater than the size of the spine or edge side of the book, the top or bottom side of book sheets is the long side of the book sheets. Further, when the spread size of the book is less than the size of the spine or edge side of the book, the top or bottom side of a cover is the short side of the cover.

The bookbinding apparatus 3 cuts cover C in such a manner that the length of the short side of the cover C is the same as the length of the long side of book sheets H and that the length of the long side of the cover C is the same as a value obtained by adding the thickness of a book sheet block, which is composed of book sheets bound together, to twice the length of the short side of the book sheets H. Therefore, if the length of the long side of the cover C is less than the value obtained by adding the thickness of the book sheet block to twice the length of the short side of the book sheets, there is a risk of defective bookbinding, because the bookbinding apparatus 3 is not able to wrap the book sheet block with the cover C so that they constitute a book or the like. Further, the bookbinding apparatus 3 may produce the book by cutting the book sheet block at a position away from the edge-side (fore-edge-side) side surface of the book sheet block by a predetermined distance, and at a position away from the top-side side surface of the book sheet block by a predetermined distance, and at a position away from the bottom-side side surface of the book sheet block by a predetermined distance (hereinafter, referred to as edge trimming). The bookbinding apparatus 3 produces a book by forming a book sheet block by binding plural book sheets H together, and by wrapping the book sheet block with the cut cover C after applying adhesive to a spine-side side surface of the book sheet block.

The bookbinding apparatus 3 has an allowable value with respect to the size of cover C receivable from the printing apparatus 2. Specifically, there is a risk of defective bookbinding because the bookbinding apparatus 3 does not able to receive the cover C if the length of the long side of the cover C is greater than or equal to 465 mm. Further, the size of a portion that can be cut by the bookbinding apparatus 3 is less than 60 mm. Therefore, if a value obtained by subtracting twice the length of the short side of the book sheets H and the thickness of the book sheet block from the length of the long side of the cover C is greater than or equal to 60 mm, there is a risk of defective bookbinding in which a part of the cover C sticks out from the book sheet block.

Next, the computer 4 will be described. The computer 4 includes a display unit 4A, an input unit 4B, and a main body 4C. The display unit 4A is a display device, such as a liquid crystal monitor, and displays a manuscript data generation program, a printer driver, and a data edit program. The input unit 4B is an input device, such as a keyboard, a mouse, and a pointing device. The input unit 4B receives an operation for the manuscript data generation program, the printer driver, and the data edit program.

The main body 4C includes a central processing unit (CPU), a semiconductor memory, a hard disk, and the like. The computer 4 functions as a manuscript data generation unit 42, a print output unit 43, and a data edit unit 44 by installing the manuscript data generation program, the printer driver, and the data edit program in the main body 4C. The memory 41 stores the manuscript data generation program, the printer driver, the data edit program, manuscript data DD and image data GD. The manuscript data DD and the image data GD may be generated by a computer other than the computer 4.

The manuscript data generation unit 42 generates manuscript data DD. As the manuscript data generation program, a program, such as Word, Excel (Registered Trademark), and Power Point (Registered Trademark) of Microsoft, may be used to generate a manuscript, and a program, such as a PDF (Registered Trademark) driver, may be used to convert the manuscript into manuscript data.

The manuscript data generation unit 42 forms an image of cover manuscript CD (hereinafter, referred to as cover manuscript image CDG) and an image of book sheet manuscript HD (hereinafter, referred to as book sheet manuscript image HDG) based on a user's operation received at the input unit 4B while the cover manuscript image CDG and the book sheet manuscript image HDG are displayed on the display unit 4A. Further, the manuscript data generation unit 42 generates manuscript data DD in PDF (Portable Document Format) format. The manuscript data generation unit 42 adds page information and index information about the book sheet manuscript HD to the book sheet manuscript data HDD. The print output unit 43 receives image data GD from the data edit unit 44, and generates print data PD, and outputs the print data PD to the printing apparatus 2. When the data edit unit 44 performs print processing, and the printer driver is started, the computer 4 functions as the print output unit 43.

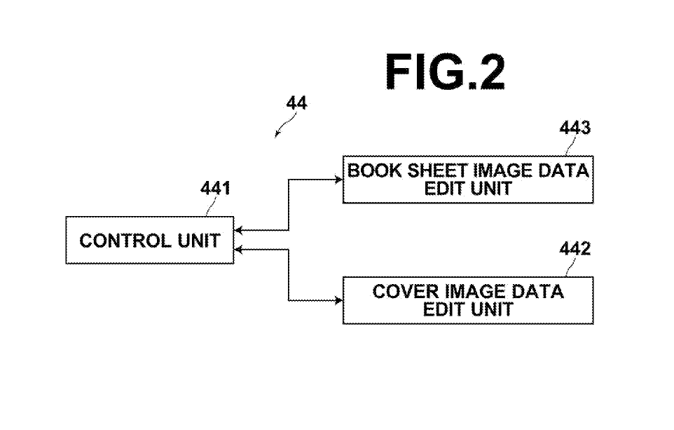

The data edit unit 44 generates image data GD of each book or the like based on manuscript data DD. The data edit unit 44 generates cover image data CGD based on the cover manuscript data CDD, and generates plural sets of book sheet image data HGD based on the book sheet manuscript data HDD. FIG. 2 is a block diagram of the data edit unit 44. As illustrated in FIG. 2, the data edit unit 44 includes a control unit 441, a cover image data edit unit 442, and a book sheet image data edit unit 443.

The control unit 441 controls the whole computer 4, as the data edit unit 44, by controlling each of the aforementioned units, the display unit 4A and the input unit 4B. The control unit 441 reads out, from the memory 41, manuscript data DD that have been specified by a user and received by the input unit 4B.

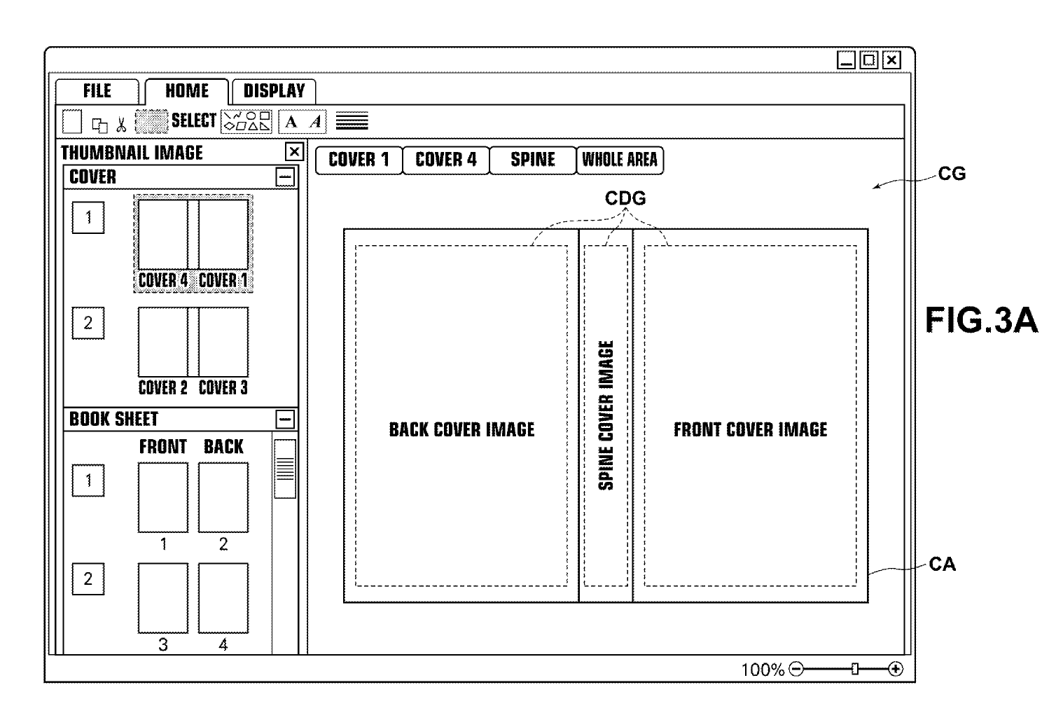

The cover image data edit unit 442 edits cover image data CGD of each book or the like based on cover manuscript data CDD. FIGS. 3A and 3B illustrate screens for editing cover image CG. After the cover image data edit unit 442 sets the size of cover edit area CA, the cover image data edit unit 442 displays cover image CG by arranging cover manuscript image CDG in the cover edit area CA, as illustrated in FIGS. 3A and 3B. Further, the cover image data edit unit 442 displays thumbnail images of the cover image CG. Further, a user operates the input unit 4B so that the cover manuscript image CDG in the cover edit area CA has a desirable position, direction and size while referring to the cover image CG. The cover image data edit unit 442 edits cover image data CGD based on operation information received by the input unit 4B. Setting of the cover edit area CA will be described later.

As illustrated in FIGS. 3A and 3B, the cover image CG includes a front cover image, a spine cover image, a back cover image, an image on the back side of a front cover, an image on the back side of a spine cover, and an image on the back side of a back cover. FIGS. 3A and 3B illustrate cover image CG of cover C for left-side binding. However, edit by the data edit unit 44 is not limited to edit of cover image data CGD for left-side binding. The data edit unit 44 may be used to edit cover image data CGD for right-side binding or top binding.

The cover image data edit unit 442 may change the order of arrangement of the front cover image, the spine cover image, the back cover image, the image on the back side of the front cover, the image on the back side of the spine cover, and the image on the back side of the back cover in the cover edit area. The cover image data edit unit 442 may change the order of arrangement of the images based on binding position information for bookbinding that has been received by the input unit 4B, in other words, whether cover C is for left-side binding, or right-side binding, or top binding.

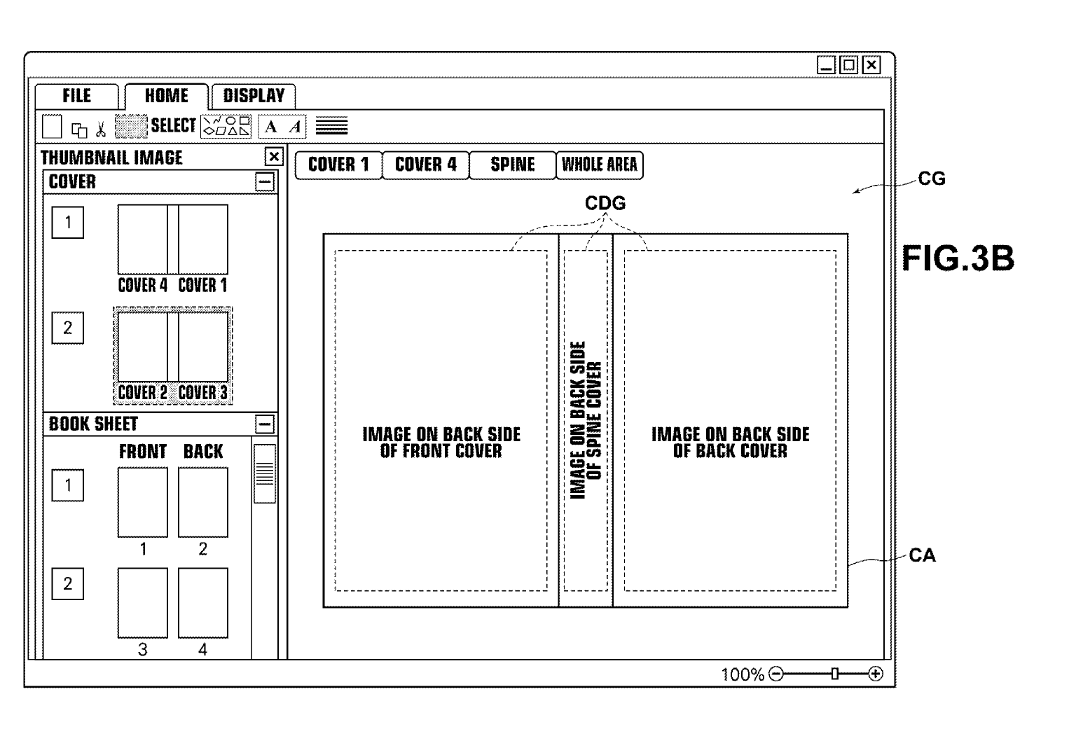

The book sheet image data edit unit 443 edits book sheet image data HGD of each book or the like based on book sheet manuscript data HDD. FIG. 4 illustrates a screen for editing book sheet image HG. After the book sheet image data edit unit 443 sets the size of book sheet edit area HA, the book sheet image data edit unit 443 arranges book sheet manuscript images HDG in the book sheet edit area HA and displays each book sheet image HG in the order of pages based on the book sheet manuscript data HDD, as illustrated in FIG. 4. Further, the book sheet image data edit unit 443 displays a thumbnail image of each book sheet image HG. A user operates the input unit 4B so that the book sheet manuscript image HDG in the book sheet edit area HA has a desirable position, direction and size while referring to the book sheet image HG. The book sheet image data edit unit 443 edits book sheet image data HGD based on operation information received at the input unit 4B.

Further, the book sheet image data edit unit 443 arranges, based on imposition setting information received by the input unit 4B, book sheet manuscript images HDG corresponding to the number of pages of imposition setting in a book sheet blank image. Further, the book sheet image data edit unit 443 displays identification as to whether each book sheet image HG belongs to a front side of a book sheet or a back side of the book sheet. The book sheet image data edit unit 443 displays such identification based on print condition information received by the input unit 4B, and the print condition information represents whether print is one side printing or both sides printing.

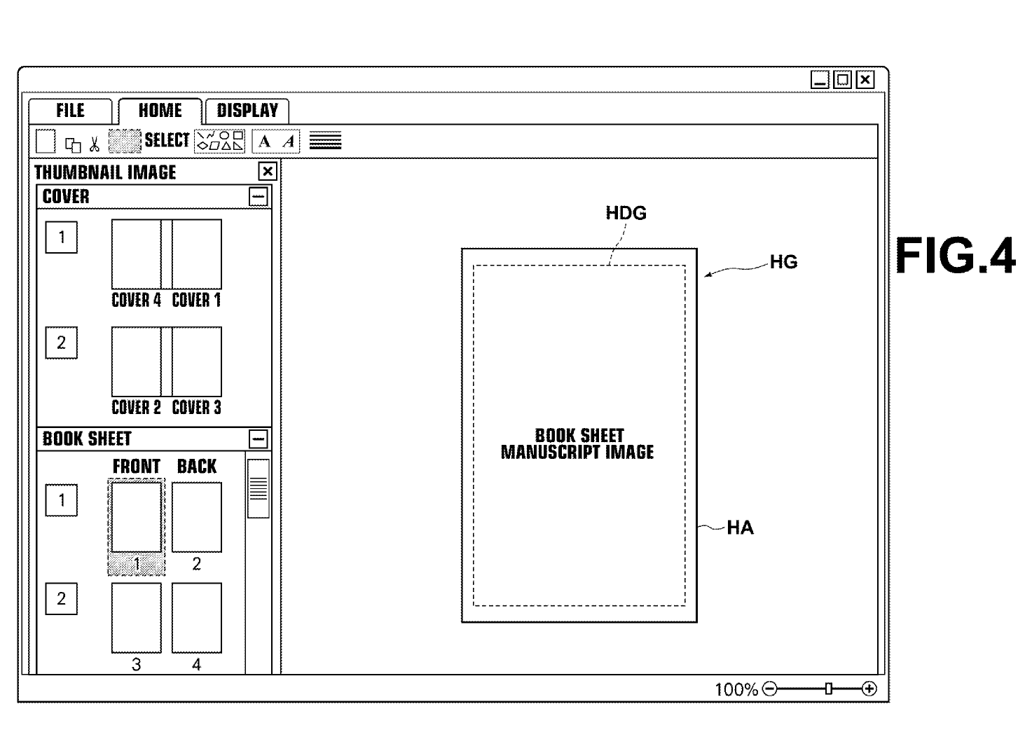

Next, setting of book sheet edit area HA and cover edit area CA will be described. The control unit 441 makes the display unit 4A display a screen for setting, as illustrated in FIG. 5. Further, the control unit 441 makes the input unit 4B receive an input of various kinds of information by a user, such as a binding position, whether printing is both side printing or not, the size of paper for book sheets H, selection of a tray for paper for book sheets, thickness W of a spine cover, length CL of the long side of the cover, and selection of a tray for paper for the cover.

In FIG. 5, the size of book sheets H is received by an input of the format of paper. However, the method for receiving the size of book sheets H is not particularly limited as long as the values of length HL1 of the long side of book sheets H and length HL2 of the short side of the book sheets H are recognizable. It is needless to say that length HL1 of the long side and length HL2 of the short side may be directly input. Similarly, the method for receiving the thickness of the spine cover and length CL of the long side of the cover is not limited to direct input of values. Alternatively, the number of book sheets H and the thickness of a book sheet may be input as the thickness of the spine cover, and the format of cover C may be input as length CL of the cover C.

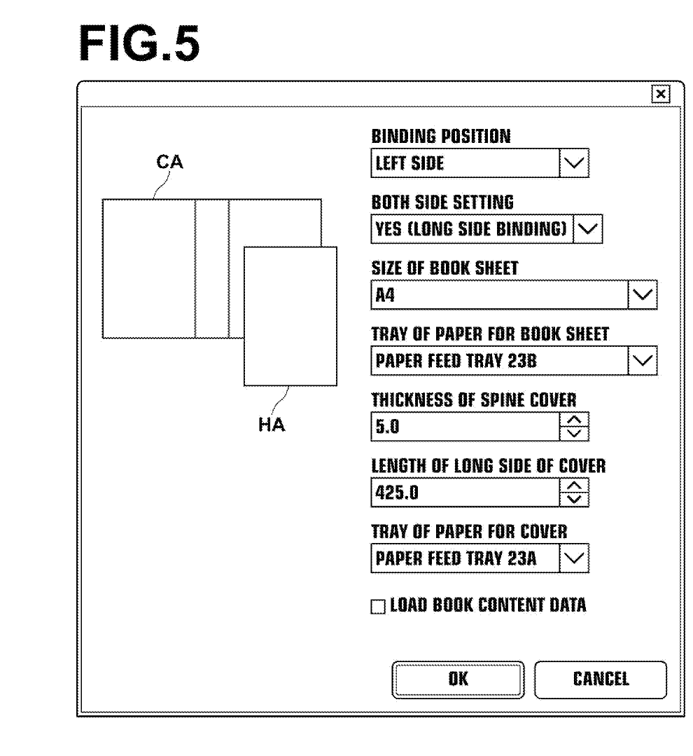

FIGS. 6A and 6B are schematic diagrams illustrating setting of book sheet edit area HA and cover edit area CA, respectively. As illustrated in FIG. 6A, the book sheet image data edit unit 443 sets book sheet edit area HA based on the size of book sheets H. Length HAL1 of the long side of the book sheet edit area HA is the same as length HL1 of the long side of book sheets H in the size of book sheets that has been input, and length HAL2 of the short side of the book sheet edit area HA is the same as length HL2 of the short side of the book sheets H in the size of book sheets that has been input. Here, when the aforementioned edge trimming is to be performed, length HL1 of the long side and length HL2 of the short side may be longer by the size of an edge portion to be trimmed in edge trimming. The cover image data edit unit 442 sets cover edit area CA based on the size of book sheets H and length CL of the long side of cover C. Length CAL1 of the long side of the cover edit area CA is the same as the length CL of the long side of cover C that has been input. Further, length CRL2 of the short side of the cover edit area CA is the same as length HL1 of the long side of book sheets H in the size of book sheets that has been input in a similar manner to the length of the long side of the book sheet edit area HA.

As clearly illustrated in FIGS. 6A and 6B, when length CL of the long side of cover C is less than a value obtained by adding thickness W of a spine cover to twice length HL2 of the short side of book sheets H, the cover edit area CA does not have a sufficient area to wrap a book sheet block to constitute a book or the like. Therefore, the control unit 441 judges, based on an input by a user in the screen for setting illustrated in FIG. 5, whether input information satisfies the following formula:

[Length HL2 of Short Side of Book Sheet H]×2+[Thickness W of Spine Cover]>[Length CL of Long Side of Cover C].

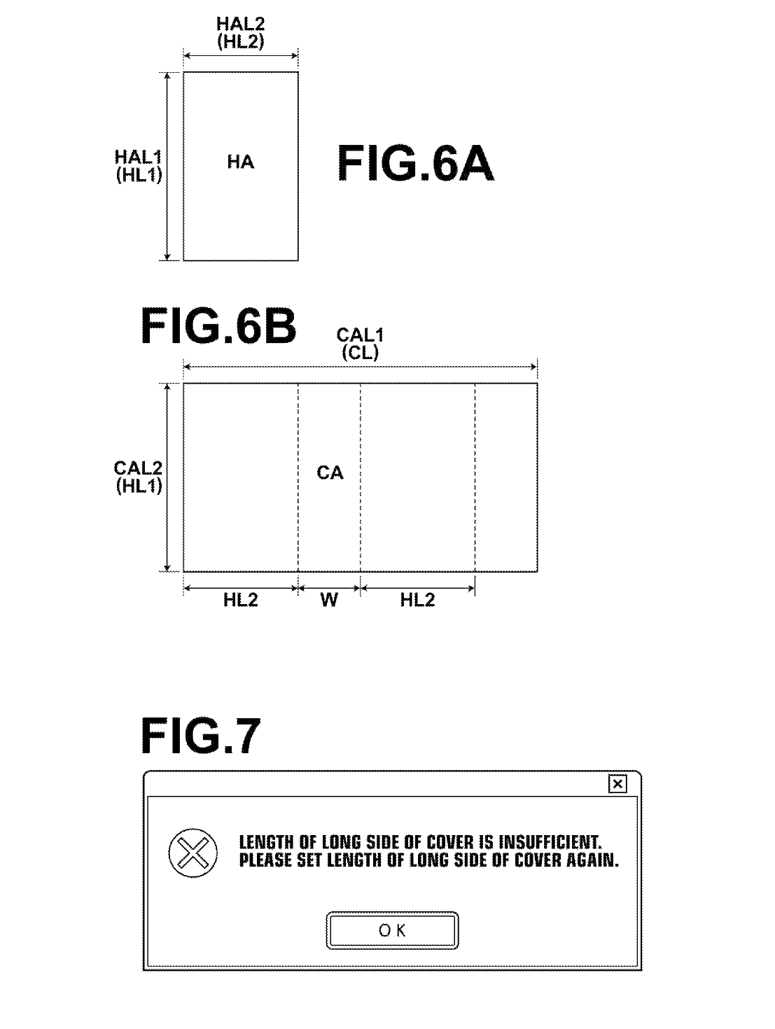

If the formula is satisfied, an alert screen, as illustrated in FIG. 7, is displayed to alert the user, and to urge the user to change at least one of the size of book sheets, thickness W of the spine cover, and length CL of the long side of cover C. Accordingly, the cover edit area CA is possible to have a sufficient area to wrap a book sheet block to constitute a book or the like.

Further, as described above, if the value obtained by subtracting twice length HL2 of the short side of book sheets H and thickness W of a book sheet block from length CL of the long side of cover C is greater than or equal to 60 mm, the size of a portion to be cut exceeds the size of a portion that can be cut by the bookbinding apparatus 3. Therefore, the control unit 441 judges, based on information input by a user in the screen for setting illustrated in FIG. 5, whether the input information satisfies the following formula:

[Length CL of Long Side of Cover C]−[Length HL2 of Short Side of Book Sheet H]×2−[Thickness W of Spine Cover]≧60 mm.

The control unit 441 displays the alert screen as illustrated in FIG. 7 also when the above formula is satisfied. The alert screen is displayed to urge the user to change at least one of the size of the book sheets, thickness W of the spine cover, and length CL of the long side of cover C. Accordingly, it is possible to prevent defective bookbinding in which a part of cover C sticks out from the book sheet block. Here, the size of the portion that can be cut by the bookbinding apparatus 3 may be determined based on the specification of the apparatus, itself. Therefore, the value is not limited to 60 mm.

Further, as described above, if length CL of the long side of cover C is greater than or equal to 465 mm, it is impossible for the bookbinding apparatus 3 to receive the cover C. Therefore, there is a risk of defective bookbinding. Hence, the control unit 441 judges, based on information input by a user in the screen for setting illustrated in FIG. 5, whether the input information satisfies the following formula:

[Length CL of Long Side of Cover C]≧465 mm.

The control unit 441 displays the alert screen as illustrated in FIG. 7 also when the above formula is satisfied. The alert screen is displayed to urge the user to change the length CL of the long side of the cover C. Accordingly, it is possible to prevent defective bookbinding in which the bookbinding apparatus 3 cannot receive the cover C. Here, the size of the cover C that cannot be received by the bookbinding apparatus 3 may be determined based on the specification of the apparatus, itself. Therefore, the value is not limited to 465 mm.

The control unit 441 continues to receive setting of book sheet edit area HA and cover edit area CA until the received input satisfies none of the aforementioned three formulas. When none of the three formulas is satisfied, the control unit 441 ends receiving the input. Further, in the screen for setting illustrated in FIG. 5, selection of a tray of paper for book sheets and selection of a tray of paper for a cover are also received. Therefore, when a print operation is performed, the control unit 441 judges, by communicating with the printing apparatus 2, whether paper for a cover stored in the paper feed tray 23A is larger than cover edit area CA, and whether paper for book sheets stored in the paper feed tray 23B is larger than book sheet edit area HA. The control unit 441 displays an alert screen when at least one of such conditions is not satisfied.

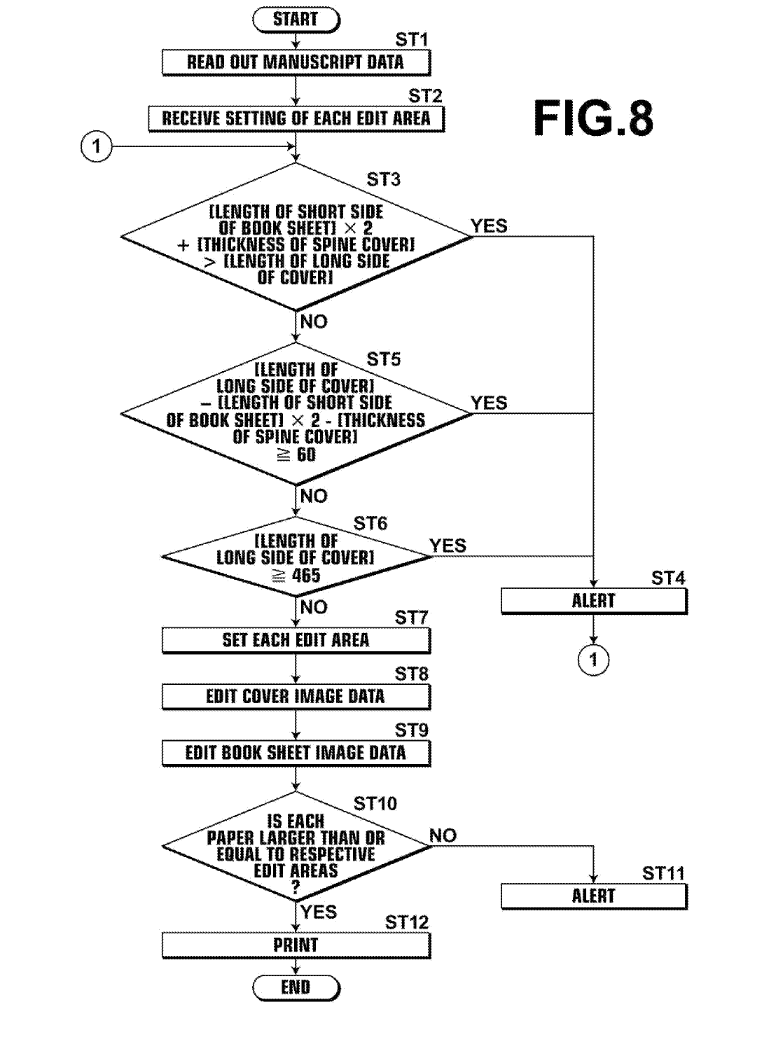

Next, the action of the data edit unit 44 will be described. FIG. 8 is a flow chart illustrating a series of processing performed by the data edit unit 44. The control unit 441 reads out manuscript data DD specified by a user (step ST1). The control unit 441 displays a screen for setting, and makes the input unit 4B receive setting of book sheet edit area HA and setting of cover edit area CA (step ST2). The control unit 441 judges, based on the received information, whether length CL of the long side of cover C is less than a value obtained by adding thickness W of a spine cover to twice length HL2 of the short side of book sheets H (step ST3). If the length CL of the long side of cover C is less than the value obtained by adding thickness W of the spine cover to twice length HL2 of the short side of book sheets H, an alert screen is displayed to urge the user to change the setting (step ST4).

When length CL of the long side of cover C is greater than or equal to the value obtained by adding thickness W of the spine cover to twice length HL2 of the short side of book sheets, the control unit 441 further judges whether a value obtained by subtracting twice the length HL2 of the short side of the book sheets H and the thickness W of the spine cover from length CL of the long side of the cover C is greater than or equal to 60 mm (step ST5). If the value obtained by subtracting twice the length HL2 of the short side of the book sheets H and the thickness W of the spine cover from length CL of the long side of the cover C is greater than or equal to 60 mm, an alert screen is displayed to urge the user to change the setting (step ST4). When the value obtained by subtracting twice the length HL2 of the short side of the book sheets H and the thickness W of the spine cover from length CL of the long side of the cover C is less than 60 mm, the control unit 441 further judges whether the length CL of the long side of the cover C is greater than or equal to 465 mm (step ST6). If the length CL of the long side of the cover C is greater than or equal to 465 mm, an alert screen is displayed to urge the user to change the setting (step ST4). If the length CL of the long side of the cover C is less than 465 mm, the control unit 441 sets book sheet edit area HA and cover edit area CA (step ST7).

The cover image data edit unit 442 edits cover image data CGD (step ST8), and the book sheet image data edit unit 443 edits book sheet image data HGD (step ST9). Further, when print processing is executed, the control unit 441 judges, by communicating with the printing apparatus 2, whether the size of paper for a cover stored in the paper feed tray 23A and the size of paper for book sheets stored in the paper feed tray 23B are smaller than the size of cover edit area CA and the size of book sheet edit area HA, respectively (step ST10). If the size of paper for a cover is smaller than the size of the cover edit area CA, or if the size of paper for book sheets is smaller than the size of the book sheet edit area HA, an alert screen is displayed (step ST11). If the size of paper for a cover and the size of paper for book sheets are larger than or equal to the size of the cover edit area CA and the size of the book sheet edit area HA, respectively, processing for printing book sheets H and cover C is performed (step ST12), and processing ends. Here, the order of judgment in step ST3, step ST5 and ST6 is not particularly limited.

As described above, according to the embodiments of the present invention, when the control unit 441 receives setting of book sheet edit area HA and cover edit area CA, if the length CL of the long side of cover C is less than a value obtained by adding the thickness W of the spine cover to twice the length of the short side of the book sheets H, an alert is issued to urge the user to change setting. Therefore, it is possible to secure cover edit area CA the size of which is sufficient to constitute a book or the like by wrapping the book sheet block. Hence, it is possible to prevent defective bookbinding in which the cover is too small to wrap the book sheet block.

According to the embodiments of the present invention, when the control unit 441 receives setting of book sheet edit area HA and cover edit area CA, if a value obtained by subtracting twice the length of the short side of the book sheet edit area HA and the thickness W of the spine cover from the length CL of the long side of the cover edit area CA is greater than or equal to the size of a portion that can be cut, an alert is issued to urge the user to change setting. Therefore, it is possible to prevent defective bookbinding in which apart of cover C sticks out from the book sheet block.

Further, according to the embodiments of the present invention, the control unit 441 issues an alert to urge the user to change setting if the length of the long side of cover edit area CA is greater than or equal to the size of paper that can be received by the bookbinding apparatus 3. Therefore, it is possible to prevent defective bookbinding caused by the size of cover C that is not receivable by the bookbinding apparatus 3.

What is claimed is:

1. A data editing apparatus for performing a bookbinding operation, in which book sheets and a cover are printed based on image data, and the book sheets are wrapped with the cover, the apparatus comprising:
an input receiving unit that receives, from a user, an input of pieces of information about the length of the top or bottom side of the book sheets, the length of the top or bottom side of the cover, and the thickness of a spine cover of the cover to set an edit area of the cover represented by the image data; and
an alert unit that judges, based on the received pieces of information, whether the length of the top or bottom side of the cover is less than a value obtained by adding the thickness of the spine cover to twice the length of the top or bottom side of the book sheets, and that issues an alert for urging the user to change at least one of the pieces of information when the length of the top or bottom side of the cover is less than the value obtained by adding the thickness of the spine cover to twice the length of the top or bottom side of the book sheets.

2. A data editing apparatus, as defined in claim 1, wherein the alert unit issues the alert when a value obtained by subtracting twice the length of the top or bottom side of the book sheets and the thickness of the spine cover from the length of the top or bottom side of the cover is greater than or equal to a threshold.

3. A data editing apparatus, as defined in claim 1, wherein the alert unit issues an alert to urge the user to change the piece of information about the length of the top or bottom side of the cover when the length of the top or bottom side of the cover is greater than or equal to a second threshold.

4. A data editing apparatus, as defined in claim 2, wherein the alert unit issues an alert to urge the user to change the piece of information about the length of the top or bottom side of the cover when the length of the top or bottom side of the cover is greater than or equal to a second threshold.

5. A non-transitory computer-readable recording medium storing therein a data editing program for editing image data to perform a bookbinding operation, in which book sheets and a cover are printed based on the image data, and the book sheets are wrapped with the cover, the program causing a computer to function as:
an input receiving unit that receives, from a user, an input of pieces of information about the length of the top or bottom side of the book sheets, the length of the top or bottom side of the cover, and the thickness of a spine cover of the cover to set an edit area of the cover represented by the image data; and
an alert unit that judges, based on the received pieces of information, whether the length of the top or bottom side of the cover is less than a value obtained by adding the thickness of the spine cover to twice the length of the top or bottom side of the book sheets, and that issues an alert for urging the user to change at least one of the pieces of information when the length of the top or bottom side of the cover is less than the value obtained by adding the thickness of the spine cover to twice the length of the top or bottom side of the book sheets.
